(19) United States
(12) Patent Application Publication
(10) Pub. No.: US 2006/0102275 A1
(43) Pub. Date: May 18, 2006

(54) Method of making a filter cartridge

(76) Inventor: Jorgen Poulsen, Narsrov (DK)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/210,151

(22) Filed: Aug. 23, 2005

Related U.S. Application Data
(60) Provisional application No. 60/628,974, filed on Nov. 18, 2004.

(51) Int. Cl. B32B 37/00

(52) U.S. Cl. 156/228; 210/493.1; 55/521; 156/308.2

(57) ABSTRACT

When, according to the invention, making a filter cartridge of pleated material by a method wherein the layers of material (1, 2) are disposed with a small overlap (3), and then, by means of a welding tool (5, 6, 7), welding the material starting at the center and then to each side until the entire overlap has been welded together, the expansion of the material in the welding may be accommodated, without the welded-together filter material losing its shape.

### CROSS-REFERENCE TO RELATED APPLICATIONS

This application claims priority from Provisional Patent Application No. 60/628,974, filed Nov. 18, 2004.

### TECHNICAL FIELD

The invention relates to a method of making a filter cartridge of the type defined in the introductory portion of Claim 1.

### BACKGROUND OF THE INVENTION

In many places in the industry, it is desirable or necessary to carry out some form of cleaning or filtering-off of the particles carried by an air stream. Therefore, it is also desirable to reduce the escape of particles from machinery or process systems to the surroundings, partly to create a healthier environment, and partly to utilize the particles filtered off as components of a product, if possible.

There are many ways in which particles may be separated from an air stream. The most common methods for separating particles from air are to pass the air through a form of filter, which filter may be a more or less fine-meshed net, depending on the size of the particles which are to be separated from the air stream. Filters and filter materials are well known for such use.

Essentially, the same criteria apply to the separation of particles from a flow of liquid.

A simple way of filtering or separating is to use a form of “filter bag,” which is a kind of vacuum cleaner bag through which the air to be cleaned or separated is forced to pass through. The bag may be made of fabric with a suitable “mesh size.” For this technology to be efficient, very large filter surfaces, and thereby enormous filter housings are required.

Another way of performing the separation is to convey or pass the air stream through a dedicated filter medium. This filter medium will frequently be made with a pleating of the filter material to obtain a surface as large as possible so that the physical extent of the filter itself is as small as possible. Thus, it is possible partly to use existing filter housings, which otherwise use filter bags, in a more efficient way, and partly to construct new smaller filter housings.

To replace the filter bags in existing filter housings, that is, to replace the filter bags with a filter cartridge or insert pleated filter material, it is necessary for the filter cartridge to be placed in the same mounting hole. This makes it necessary to have a very long filter cartridge.

The filter cartridge itself is not made in such lengths, since the pleated material used as a filter material is not made in lengths above 2-2.5 meters. Since, in several cases, it is necessary to insert filter cartridges in lengths of up to 4 meters, it is necessary to join two filter cartridges in extension of, or in series with, each other. This is described in EP 1 307 272, wherein it is shown to have special joining brackets on the outer side of the two filter cartridges to obtain the desired filter length.

Further, use is made of a form of intermediate members for joining and sealing the two filter cartridges, said intermediate members extending into the filter itself. This is very inexpedient, in particular in filter systems where it is important that there are no cracks, gaps or joints in which germs and bacteria can grow. In addition, both seals and intermediate members result in a smaller cross-sectional area for the flow through the filter itself.

The joining brackets are also necessary in order to impart the required rigidity to the joined filters when they are to be maneuvered after having been joined.

When two separate filters are joined to one filter element, a considerable constriction occurs in the transition between the two separate filters, and this constriction has an adverse impact on the pulsation of the air flow, also called pulse air, which is used for the cleaning of the filter. An interruption occurs precisely at the joining point, and the pulse air necessary for the cleaning is spread in various directions, whereby the pulse air will counteract itself. As a result, the necessary pulsation of the air stream or the pulse air does not extend in the entire extent of the filter. Therefore, the particles which are stuck in the filter and which are to be released by the cleaning process by means of the pulse air method, are not loosened and released in the entire filter, but only in the upper part. Particles and dust will hereby accumulate in the lower part of the joined filter, which contributes to reducing the flow of air through the filter, thereby reducing the active filter area.

### SUMMARY OF THE INVENTION

The novelty of the invention is that it is possible to make filter cartridges in lengths above 2-2.5 meters without the formation of “pockets” in connection with the filter cartridge which are difficult to clean or disinfect when cleaning the filter system.

If two or more lengths of pleated material are to be welded together by means of ultrasound, there is a range of factors which cause the end result to not be satisfactory in all cases.

If two lengths of pleated material are disposed in extension of, or in series with, each other such that the pleats extend with their tops and bottoms in the longitudinal direction and with a small overlap, the welding tool is arranged on its respective side of the upper and lower sides of the pleated material. Since the costs and the energy consumption of a tool extending in the entire width of the pleats are too high, it is expedient to restrict the tool to welding across the width.

If this process is performed by welding from one edge toward the other edge, an inexpedient displacement of the material rapidly takes place, as the material expands during the process.

To avoid these inexpedient displacements of the material, a method is applied according to the invention, wherein, prior to assembly, the lengths are positioned so as to create an overlap, following which a welding tool is arranged on each side of the central part of the overlap for welding together, following which the tool is moved laterally for welding the adjacent part, following which this is repeated until the weld reaches the side edge, following which the opposite side of the lengths is welded together in a similar manner.

First, the material is welded together in the center, and then welding is performed against each edge, either first towards the one edge and then towards the other edge, or by an alternating method, as stated in Claim 2, by starting from the center and then alternately welding one or more “tops” of the pleating first toward the one edge, then toward the other edge until both outer edges have been reached.

By using this method, it is possible to control or restrict the expansion of the material, thereby making it possible to produce a long pleated web which extends with parallel pleats in its entire length.

When, as stated in Claim 3, the welded-together, pleated material is rolled up to form a tube which is pleated in its longitudinal direction, the joining may take place by means of end members, preferably of a synthetic material or another resilient material, which end members may form a seal between a filter housing and the pleated tube.

This assembly according to the invention provides an assembly of pleated filter material which just has an edge in the assembly in a downward direction on the “unclean” side of the filter. This means that in the cleaning of the filter, e.g., by the pulse air method, any particles which have accumulated on this edge will sift down by this cleaning method or can at any rate be removed easily by means of a jet of air or water.

Moreover, the assembly according to the invention provides a stiffening of the central area of the filter, without this stiffening giving rise to formation of germs or bacteria.

### BRIEF DESCRIPTION OF THE DRAWINGS

An example of the assembly of pleated material for the making of filter cartridges in long lengths will be described below with reference to the drawings, in which

FIG. 1 shows two sheets of pleated material in extension of, or in series with, each other;

FIG. 2 shows the two sheets of pleated material arranged so as to form an overlap;

FIG. 3 shows a tool which is slidable relative to the objects to be assembled and is arranged in place prior to joining and welding;

FIG. 4 shows the pleated material in a joined state.

### DETAILED DESCRIPTION OF THE INVENTION

Pleated material in a width fitting a given diameter of a filter cartridge is placed in a fixture (not shown) of a generally known type, so that the pleated material is held in a partly stretched form. The pleated material is placed such that a plane through the tops of the pleats constitutes an essentially plane face.

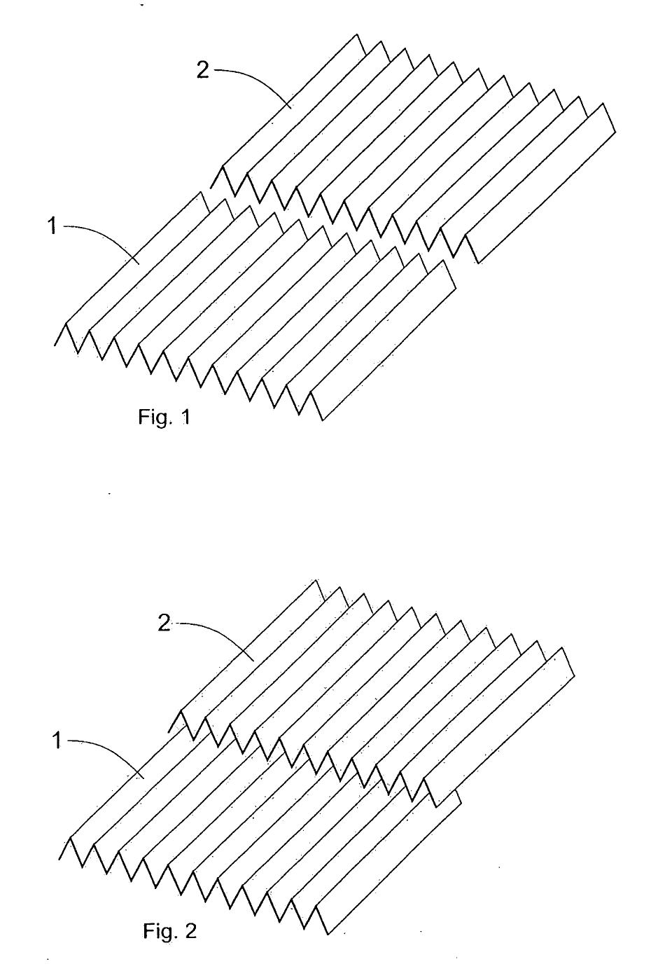

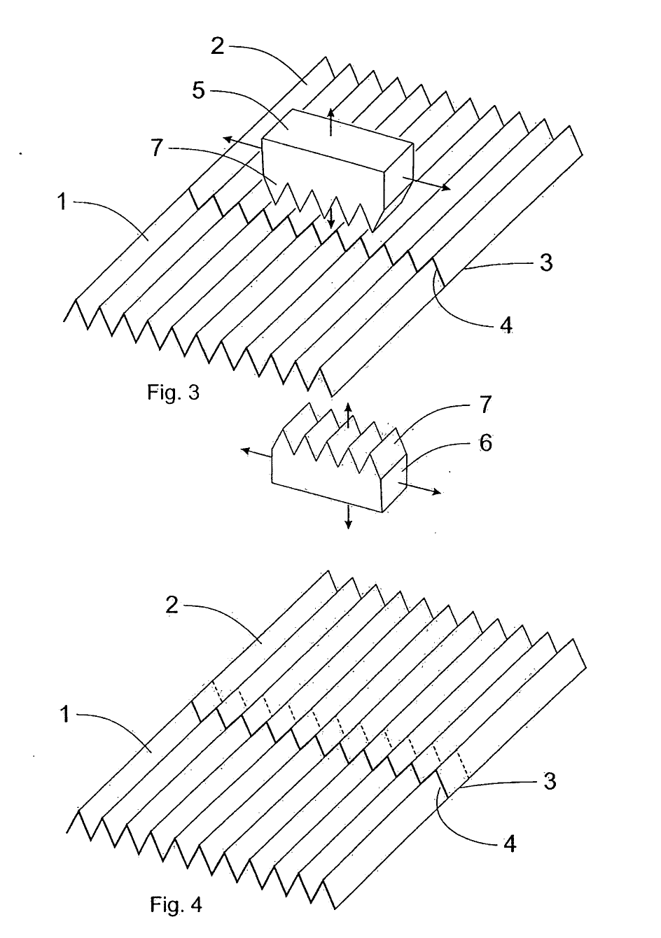

FIG. 1 shows two sheets of pleated material 1, 2 which are about to be placed in extension of, or in series with, each other and with a small overlap in an area 3, where the one sheet 1 is to be joined with the other sheet 2.

FIG. 2 shows two sheets of pleated material 1, 2 arranged in extension of, or in series with, each other with a small overlap 3. The overlap 3 is arranged such that the edge 4 produced by the overlap 3 will be present on the clean side of the filter, when this is assembled to a filter cartridge or the like. This facilitates subsequent cleaning of the filter.

In the actual attachment of the two sheets of pleated material 1, 2 to each other, a portion of the overlap 3 is pressed together between tools 5, 6 which are present on each side (above and below) the pleated sheets 1, 2.

The tools 5, 6, which are provided with serrations 7 intended to fit between the serrations of the pleats, thus hold the two sheets 1, 2.

When the tools have been pressed together around the pleated sheets 1, 2, a high frequency of sound corresponding to ultrasound is applied to the upper one 5 or the lower one 6 of the tools 5, 6. Accordingly, joining is carried out by means of ultrasound in the area 3 of the pleated sheets 1, 2 which overlap each other and are simultaneously present between the tools 5, 6.

If this process is performed by welding from the one edge to the other edge, an inexpedient displacement of the material rapidly takes place, as the material expends during the process.

The method according to the invention avoids these inexpedient displacements of the material by first welding the pleated sheets 1, 2 together in the area 3, where these overlap each other in the center, and then welding toward a respective edge either first toward the one edge and then toward the other edge, or by an alternating method which is performed by starting from the center and then alternately welding one or more “tops” of the pleats first toward the one edge, then toward the other edge until both outer edges are reached.

Thus, the expansion of the material is restricted, thereby making it possible to produce a long pleated web which extends with parallel pleats in its entire length.

I claim:

1. A method of making a filter cartridge by assembling two or more lengths of pleated filter material, characterized in that, prior to assembly, the lengths (1, 2) are positioned so as to create an overlap (3), following which a welding tool (5, 6, 7) is arranged on the upper side and the lower side, respectively, of the central part of the overlap (3) which is welded together, following which the tool (5, 6, 7) is moved laterally for welding the adjacent part, following which this is repeated until the weld reaches the side edge, following which the opposite side of the lengths (1, 2) is welded together in a similar manner.

2. A method according to claim 1, characterized in that the welding tool (5, 6, 7) is alternately moved to each side of the central weld.

3. A method of assembling the filter material made according to claim 2, characterized in that it is rolled up to form a tube, wherein the pleats extend in the longitudinal direction, following which end members are arranged for holding the tube together and for mounting in the filter housing.

4. A method of assembling the filter material made according to claim 1, characterized in that it is rolled up to form a tube, wherein the pleats extend in the longitudinal direction, following which end members are arranged for holding the tube together and for mounting in the filter housing.
